(19) United States
(12) Patent Application Publication
(10) Pub. No.: US 2013/0098210 A1
(43) Pub. Date: Apr. 25, 2013

(54) Bottle Cap Opener

(71) Applicant: Robert Bartz, Yakama, WA (US)

(72) Inventor: Robert Bartz, Yakama, WA (US)

(21) Appl. No.: 13/277,364

(22) Filed: Oct. 20, 2011

(51) Int. Cl. B67B 7/18

(52) U.S. Cl. 81/3.4

(57) ABSTRACT

A twist-off cap bottle opener having a varying cap engaging radii.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

This invention relates to a bottle openers and more specifically, to an opener for removing twist-off caps from a bottle. Twist-off caps are well known in the art. To remove a twist-off cap from a bottle the user, generally, grasps the cap between the thumb and a finger twisting it until it loosens.

FIG. 1 shows a twist-off cap bottle opener (10) that is known in the art. Generally, the twist-off cap bottle opener (10) is defined by a substantially circular body (11) which defines a hole. The twist-off cap bottle opener (10) has an inner surface (12) at the inner radius (r) and outer surface (13) at (r+x). The inner surface (12) defines a ratchet (14) which engages twist-off caps. In some instances, prior art twist-off cap bottle openers may have had a lever arm (15).

Flight attendants, and others in similar professions, open many twist-off cap bottles a day. Prior art twist-off cap bottle openers (10), described above, are lacking, however, because those engage a twist-off bottle cap of a defined radius.

### BRIEF DESCRIPTION OF INVENTION

Accordingly, it is an objective of the present invention to provide a twist-off cap bottle opener which overcomes the disadvantages of the prior art bottle openers. Another objective of the present invention is to provide a lever that can help prevent/reduce the symptoms of Carpel Tunnel Syndrome or help those with arthritis or other similar disabilities easily opener a twist-off cap.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a perspective view showing a prior art twist-off cap bottle opener;

FIG. 2 is a perspective view of an embodiment of the invention described herein;

FIG. 3 is a top view of an embodiment of the invention described herein;

FIG. 4 is a bottom view of an embodiment of the invention described herein;

FIG. 5 is a sectional side view of an embodiment of the invention described herein;

FIG. 6 is an end view of an embodiment of the invention described herein;

FIG. 7 is a top view of another embodiment of the invention described herein,

### DETAILED DESCRIPTION OF THE INVENTION

The present invention is described more fully hereinafter with reference to the accompanying drawings, in which preferred embodiments of the invention are shown. This invention may, however, may be embodied in many different forms and should not be construed as limited to the embodiments set for herein; rather, these embodiments are provided so that this disclosure will be thorough and complete and will fully convey the scope of the invention to those skilled in the art.

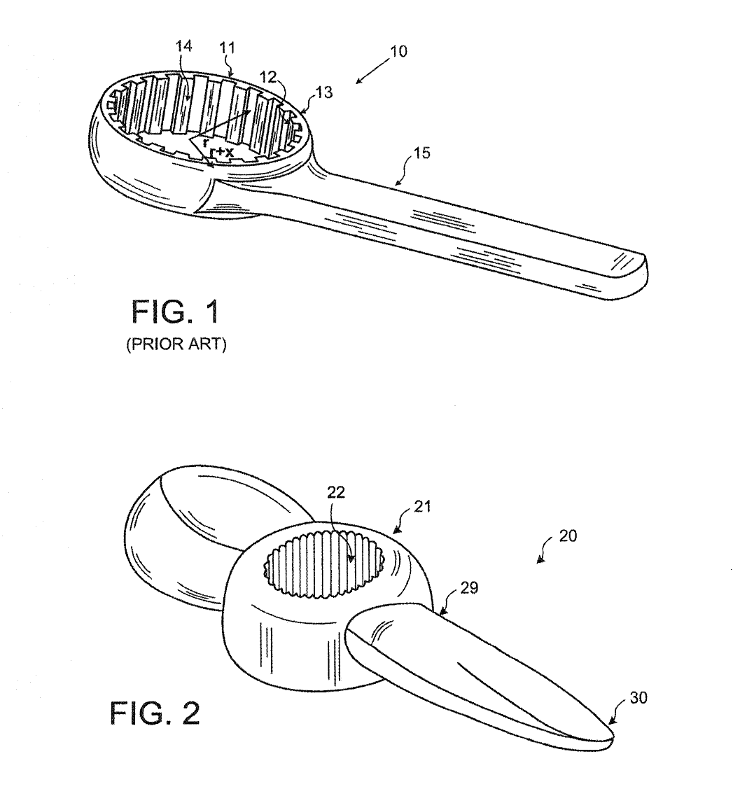

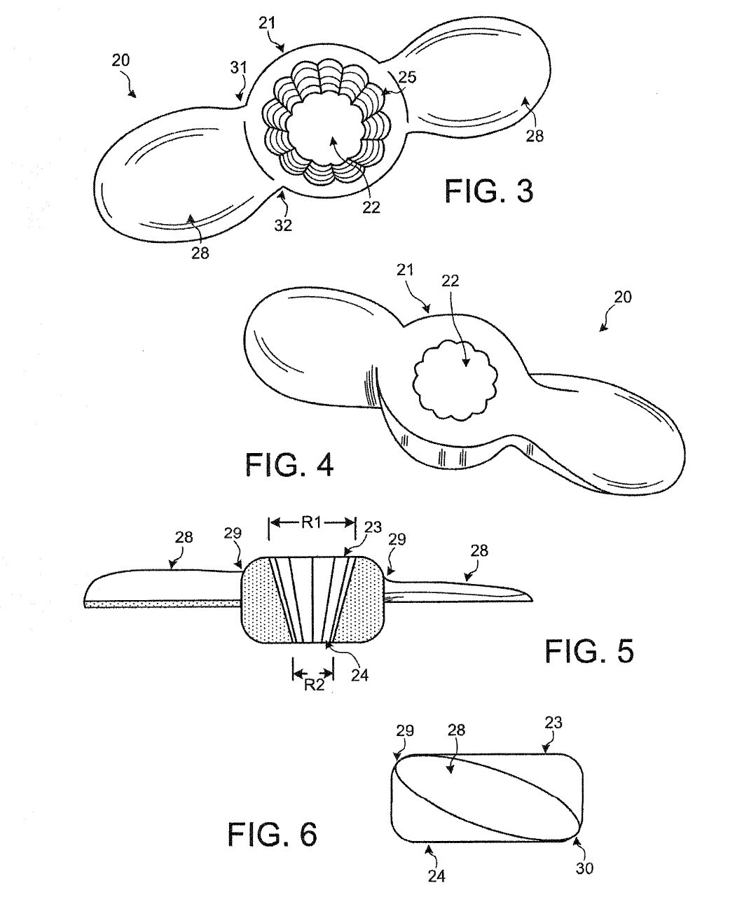

Referring now to the drawings, FIGS. 2 through 5, shows a twist-off cap bottle opener or bottle opener (20). Generally, the bottle opener (20) is defined by a substantially circular body (21) which defines a hole (22). The bottle opener (20) has a bottom (24) and a top (23). The hole (22) has a radius of R1 at the top (23) and a radius of R2 at the bottom (24) where R1≠R2 and R2<R1. The surface R1, R2 defines a ratchet (25) for engaging a twist-off bottle cap. The varying radii allow the bottle opener (20) to engage twist-off bottle caps of various sizes.

In one preferred embodiment, the substantially circular body (21) comprises at least one set of blades (28). A blade (28) comprises a near end (29) and a distal end (30). The near end is attached to the substantially circular body (21). A blade (28) further comprises a width (31, 32). The blade (28) at (31) is attached to the top (23) of the substantially circular body (21); the blade (28) at (32) is attached to the bottom (24) of the substantially circular body (21).

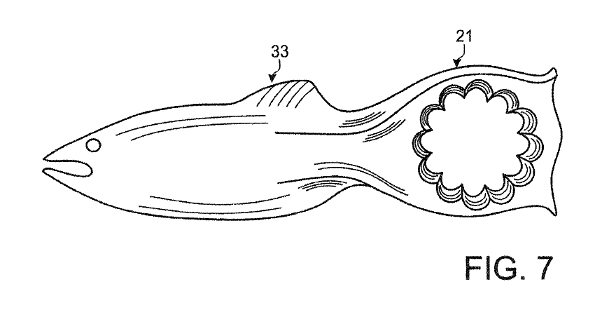

In another embodiment, as shown in FIG. 7, the substantially circular body (21) further comprises a lever arm (33). In the drawing shown, the lever arm (33) is shaped as a fish. However, the lever arm may take on any shape.

What is claimed is:

1. A twist-off cap bottle opener comprising:
a substantially circular body which defines a hole;
the substantially circular body has a bottom side and a top side;
the hole has a radius of RI at the top side and a radius of R2 at the bottom side;
where R1≠R2 and R2<R1;
where the surface at R1, R2 defines a ratchet for engaging a twist off cap.

2. The twist-off cap bottle opener of claim 1 where the substantially circular body comprises at least one set of blades.

3. The twist-off cap bottle opener of claim 2 where:
a blade comprises a near end and a distal end;
were the near end is attached to the substantially circular body.

4. The twist-off cap bottle opener of claim 3 where:
a blade further comprises a width (x, x+y);
where a blade at x is attached to the top side of the substantially circular body;
where a blade at x+y is attached to the bottom side of the substantially circular body.

5. The twist-off cap bottle opener of claim 1 where the substantially circular body further comprises a lever arm.
